(19) United States
(12) Patent Application Publication
(10) Pub. No.: US 2026/0099362 A1
(43) Pub. Date: Apr. 9, 2026

(54) Memory Swapping Method, Apparatus, Computer Device and Storage Medium

(71) Applicant: CLOUD INTELLIGENCE ASSETS HOLDING (SINGAPORE) PRIVATE LIMITED, Singapore (SG)

(72) Inventor: Hao ZHENG, Hangzhou, Zhejiang (CN)

(21) Appl. No.: 19/113,402

(22) PCT Filed: Sep. 27, 2023
(86) PCT No.: PCT/CN2023/122153

§ 371 Date: Mar. 19, 2025

(30) Foreign Application Priority Data
Oct. 11, 2022 (CN) 202211242850.3

(51) Int. Cl. G06F 9/48; G06F 12/1009

(52) U.S. Cl. CPC G06F 9/4881; G06F 9/4812; G06F 12/1009

(57) ABSTRACT

Embodiments of the present disclosure provide a memory swapping method, an apparatus, a computer device and a storage medium. The memory swapping method includes: a pending swapping task is acquired, a memory block that requires data swapping is determined according to the pending swapping task, and a swapping request corresponding to the memory block is sent to a target memory; in response to receiving a swapping completion message returned by the target memory, a first task currently being executed is interrupted, and an operation for updating page table information of the memory block is performed and a metadata update task of the memory block is added to a preset task queue, and the first task is resumed after the operation is completed; and in response to detecting that a set condition is met, the metadata update task in the preset task queue is processed.

The present disclosure claims priority of Chinese Patent Application No. 202211242850.3, filed to China National Intellectual Property Administration on Oct. 11, 2022 and titled “Memory Swapping Method, Apparatus, Computer Device and Storage Medium”, the content of which is hereby incorporated by reference in its entirety.

### TECHNICAL FIELD

The present disclosure relates to a computer technology field, and particularly relates to a memory swapping method, an apparatus, a computer device and a storage medium.

### BACKGROUND OF THE INVENTION

In order to use memory flexibly, a memory swapping module in an operating system is arranged for dynamically scheduling, which includes swap out and swap in, process data between memory and external storage (non-transitory memory, such as a disk). The memory is usually divided into multiple memory blocks. An operation of swap out refers to temporarily swaps data stored in at least one memory block out to the external storage. An operation of swap in refers to swap some data stored in a process on external storage in the at least one memory block.

In a computer, an interrupt is a mechanism used by the operating system to respond to a hardware device request. As shown in FIG. 1A, when an operating system originally executes a task 1 and receives an interruption request from a hardware device at T1 moment, the operating system interrupts the execution of the task 1 and then calls a task 2 corresponding to the interruption request in response to the interruption request. At T2 moment, the operating system completes the execution of the task 2 and resumes the execution of the task 1.

Specifically, in a memory swapping scheme, a swapping request is initiated to the external storage. After processing the swapping request, the external storage sends a completion message to the operating system as an interrupt. The operating system stops the current task and then executes a task corresponding to the interrupt before resuming the execution of the previous task.

In a traditional memory swapping scheme, a task to be executed at interrupt include updating page table information and metadata corresponding to at least one swapped memory block. Since the task to be executed includes two sets of data for updating the page table and metadata, the execution process will cost a long time, making it difficult for an operating system to quickly recover from the interrupted task. Therefore, reducing the impact on the execution of task by the operating system is required.

### SUMMARY OF THE INVENTION

In order to overcome a problem existing in related art, embodiments of the present disclosure provides a memory swapping method, an apparatus, a computer device and a storage medium.

According to a first aspect of the embodiments of the present disclosure, a memory swapping method is provided. The method includes that: a pending swapping task is acquired, a memory block that requires data swapping is determined according to the pending swapping task, and a swapping request corresponding to the memory block is sent to target memory; in response to receiving a swapping completion message returned by the target memory, a first task currently being executed is interrupted, and an operation for updating page table information of the memory block and adding a metadata update task of the memory block to a preset task queue is performed, and the first task is resumed after the operation is completed; and in response to detecting that a set condition is met, the metadata update task in the preset task queue is processed.

According to a second aspect of the embodiments of the present disclosure, a memory swapping apparatus is provided. The apparatus includes: an acquiring module, is configured to acquire a pending swapping task, determine a memory block that requires data swapping according to the pending swapping task, and send a swapping request corresponding to the memory block to target memory; a return processing module, is configured to in response to receiving a swapping completion message returned by the target memory, interrupt a first task currently being executed, and perform an operation for updating page table information of the memory block and add a metadata update task of the memory block to a preset task queue, and resume the first task after the operation is completed; and a metadata update module, is configured to in response to detecting that a set condition is met, process the metadata update task in the preset task queue.

According to a third aspect of the embodiments of the present disclosure, a computer device is provided, including a memory, a processor and a computer program stored in the memory and the computer program is executed by the processor, wherein the processor executes the computer program to implement the steps of the method embodiment as mentioned in the first aspect.

According to a fourth aspect of the embodiments of the present disclosure, a computer-readable storage medium is provided, storing a computer program, the computer program being executed by a processor to implement the steps of the method embodiment as mentioned in the first aspect.

It should be understood that the above general description and subsequent detailed descriptions are exemplary and explanatory, but do not limit the present disclosure.

### BRIEF DESCRIPTION OF DRAWINGS

The accompanying drawings are incorporated herein by reference and form a part of the present disclosure, showing embodiments that comply with the present disclosure, and used together with the specification to explain principles of the present disclosure.

FIG. 1A is a schematic diagram of an interruption according to some embodiments of the present disclosure.

FIG. 1B is a schematic diagram of a memory swapping according to some embodiments of the present disclosure.

FIG. 2A and FIG. 2B are flowcharts of a memory swapping method according to some embodiments of the present disclosure.

FIG. 2C is a schematic diagram of a reserved memory scenario according to some embodiments of the present disclosure.

FIG. 2D is a schematic diagram of a NUMA architecture according to some embodiments of the present disclosure.

FIG. 3 is a block diagram of a computer device where a memory swapping apparatus is located according to some embodiments of the present disclosure.

FIG. 4 is a block diagram of a memory swapping apparatus according to some embodiments of the present disclosure.

### DETAILED DESCRIPTION OF THE INVENTION

Here, a detailed description of exemplary embodiments will be given. The examples are shown in the drawings. When describing below with reference to the drawings, unless otherwise indicated, different numbers in different drawings represent similar or identical elements. The described implementations in the following exemplary embodiments do not represent all implementations consistent with the present disclosure. Instead, the described implementations are examples of some apparatuses and methods that are consistent with aspects as described in detail in the appended claims of the present disclosure.

The terms used in the present disclosure are for describing specific embodiments, and not intended to limit the scope of the present disclosure. The singular forms “a”, “the” and “this” as used herein also intend to include plural forms unless otherwise indicated by context. It should be understood that the term “and/or” used in the present disclosure refers to any or all possible combinations of related listed items.

It should be understood that although various information may be described using terms such as first, second, third in the present disclosure, these terms are not limited to these terms. These terms are used for distinguishing different types of information from each other. For example, without departing from the protection scope of the present disclosure, first information can also be referred to as second information, similarly, the second information can also be referred to as the first information. Depending on context, words like “if” used here could be interpreted as “during . . . ”, or “when . . . ”, or “in response to determining”.

A physical memory, such as Dynamic Random Access Memory (DRAM), of a computer is limited. Compared with the physical memory, external storage such as a disk in the computer has a very large capacity. A memory swapping module of the operating system can solve the problem of tight memory space through memory swapping. Here, the external storage usually refers to any type of storage other than main memory of the computer and cache in the Central Processing Unit (CPU). The external storage may also be referred to as secondary storage, including but not limited to a fixed or mobile hard drive or an optical disc.

Memory swapping refers to dynamically scheduling, which includes swap out and swap in, process data between memory and external storage. An operation of swap out refers to temporarily swaps data stored in some processes on the memory out to the external storage. An operation of swap in refers to swap some data stored in a process on external storage in the memory.

When a process is running, the operating system allocates virtual address space and physical address space for the process, and creates a page table corresponding to the process. The page table is used for recording a mapping relationship between the virtual address space and the physical address space. The operating system also maintains metadata for the memory managed by the operating system and the metadata is used for managing the memory. When processing the memory swapping, since a storage location of the process data has changed, the page table of the process is required to be updated. A state of a memory block has changed due to the change of the storage location of the process data, the metadata is further required to be updated.

The page table is a concept of virtual memory technology. In order to allow a program to obtain more available memory and expand physical memory into larger logical memory, the operating system further use the virtual memory technology. The operating system abstracts physical memory as an address space. For each process, the operating system allocates an independent set of virtual addresses. Virtual addresses of different processes are mapped with physical addresses of different memory. When a program is required to access a virtual address, the virtual address is converted by the operating system into different physical addresses. The concept involves two types of addresses.

A memory address used by the program is called a Virtual Memory Address (VA).

An actual space address in hardware is called a Physical Memory Address (PA).

Virtual addresses are mapped to physical addresses through a page table. The page table is stored in memory and used by MMU (Memory Management Unit) of the CPU for converting virtual memory to physical memory. When a virtual address that a process tries to access cannot be found in the page table, the system will generate a page fault, enter system kernel space to allocate physical memory, update the process table, and finally return to user space to resume the running of the process.

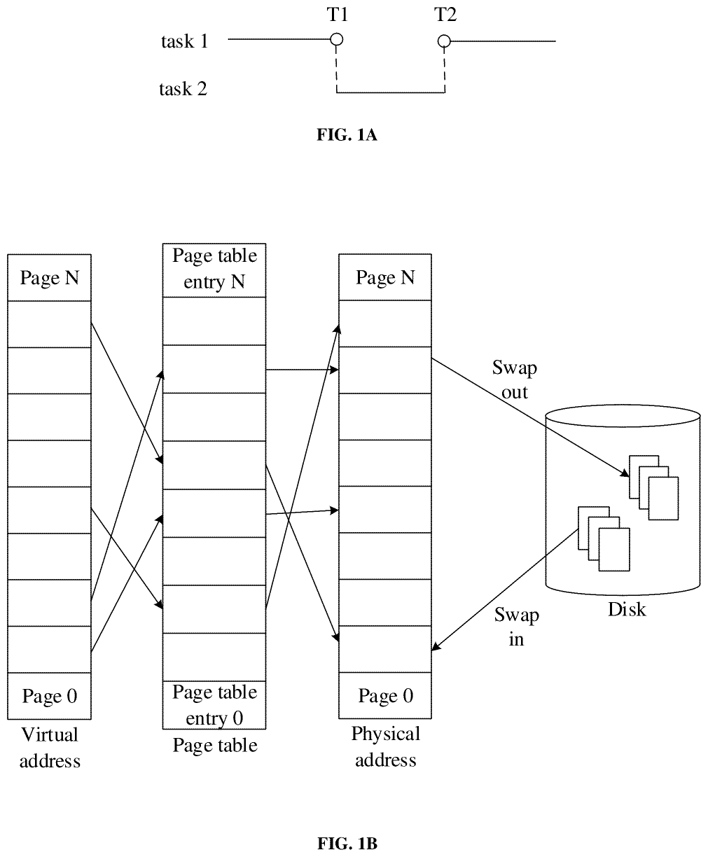

As shown in FIG. 1B, it is a schematic diagram of a memory swapping according to some embodiments of the present disclosure. In related art, the memory management unit of the operating system divides the memory into units at a predetermined granularity for management. Each unit can be called a page (page), or it may also be referred to as a block. The example takes the pages allocated by the process from 0 to N as an example, and the page table includes N page table entries. Each page table entry represents the correspondence between virtual address and physical address of every page. Thus, the entire page table records the relationship between the virtual address spaces, page tables, and physical address spaces of the process; a virtual address of the process can be mapped to its corresponding physical address through the page table when performing memory swapping. Memory swap out means that some data stored in the process on the memory are swapped with those stored in the hard disk; while memory swap in means that some data stored in the process on the hard disk are swapped with those stored in the memory. Therefore, when there is memory swapping, page table information corresponding to the swapped memory blocks is required to be updated.

Additionally, the operating system maintains metadata that records memory allocation information for managing individual memory blocks in memory; the metadata of the memory can include various types of metadata. Depending on different scenarios, the metadata may include but not be limited to metadata representing whether a memory block is allocated, total metadata of the memory or metadata representing the cold-hot state of a memory block, and metadata representing which process owns the memory block, etc. Taking virtual machine scenario as an example, in some schemes, computer devices are dedicated to virtual machines, and in the scheme of allocating memory for virtual machines, a fixed virtual address space is configured for each virtual machine. In order to facilitate query of the correspondence between virtual addresses and physical addresses, in addition to the page table data, metadata MMAP (memory map, the mapping relationship between the virtual address and physical address of memory) which represents the memory allocation situation is additionally created. The metadata can be used to achieve bidirectional query of virtual address and physical address, thereby improving querying efficiency. Therefore, when memory swapping occurs, it is necessary to update the metadata corresponding to the memory block as well.

In memory swapping schemes of related art, external storage returns a completion message for a swapping request. It is an interrupt to the operating system and the kernel enters an interrupt context mode. The tasks that need to be executed include updating both page table information and metadata. The interrupted task can only be resumed after the processing is completed. Due to the need to update two sets of data, the interruption process will take a longer time.

And in some scenarios, it may even get stuck for a long time because data update requires holding locks. The lock mechanism is designed to prevent multiple threads from competing over data, which could lead to data corruption. Threads usually add locks before operating on data; only the thread that successfully acquires the lock can operate on the data, the thread that fail to acquire the lock must wait until the lock is released.

When external storage returns a completion message for a swapping request, the operating system interrupts the current task and executes tasks to update page table information and metadata. The updating task requires holding a lock before it can be performed. At this time, the lock may be held by other threads, and requires waiting until other threads release it. Additionally, there is also a possibility that the lock is held by a task that has been interrupted, resulting in long-term blocking.

Based on this, an embodiment of the present disclosure provides a memory swapping method. In response to receiving swapping completion messages returned by target memory, after interrupting a first task currently being executed by an operating system, an operation performed by the operating system are updating page table information and adding a metadata update task of the memory block to a task queue, thereby reducing the number of executing metadata update tasks relative to conventional technologies, eliminating the need to hold locks for metadata, lowering the probability that interrupts will be stuck in long-term blockages during interruptions, and improving recovery speed from interrupts.

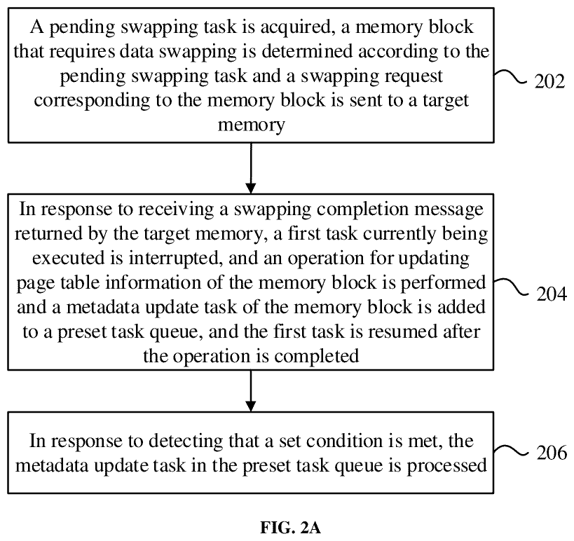

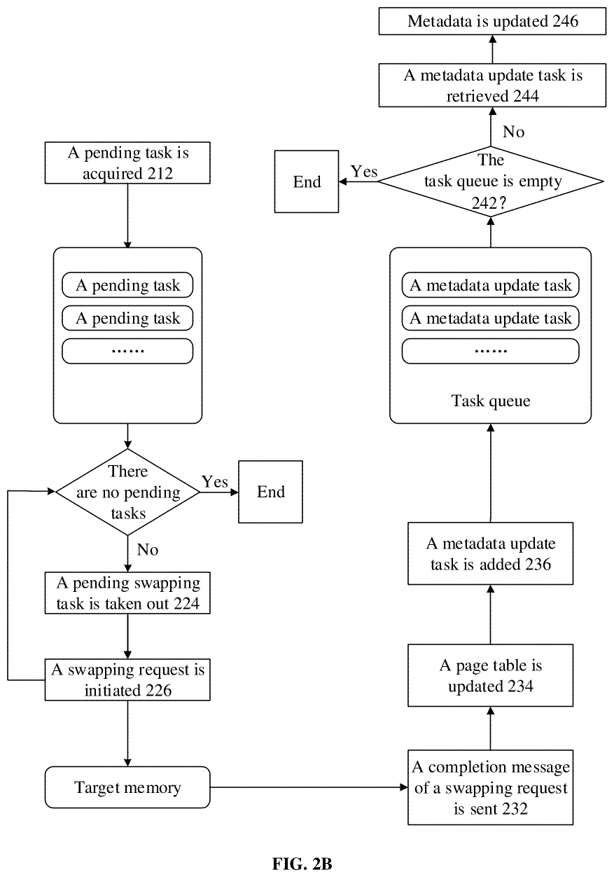

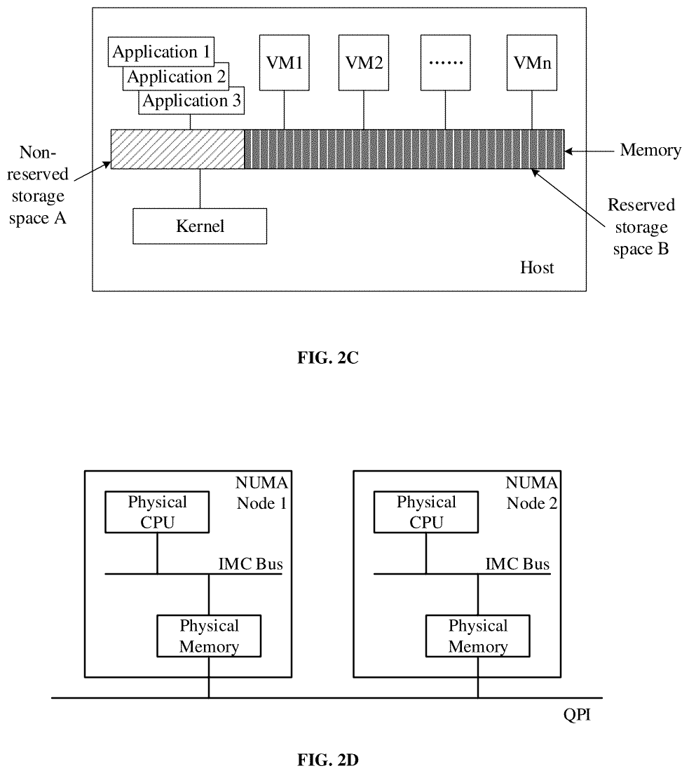

In combination with FIG. 2A and FIG. 2B, FIG. 2A and FIG. 2B are flowcharts of a memory swapping method according to some embodiments of the present disclosure, including the steps as follows:

In step 202, a pending swapping task is acquired, a memory block that requires data swapping is determined according to the pending swapping task and a swapping request corresponding to the memory block is sent to a target memory.

In step 204, in response to receiving a swapping completion message returned by the target memory, a first task currently being executed is interrupted, and an operation for updating page table information of the memory block is performed and a metadata update task of the memory block is added to a preset task queue, and the first task is resumed after the operation is completed.

In step 206, in response to detecting that a set condition is met, the metadata update task in the preset task queue is processed.

The embodiment method can be applied to the operating system of any computer device for data swapping between the memory and the target memory.

In some examples, computer devices can adopt a traditional memory management architecture in which an operating system manages all of the memory. In other scenarios, such as virtual machine scenarios, for example, computer devices may use a reserved-memory allocation architecture, as shown in FIG. 2C, is a schematic diagram illustrating a reserved memory scenario according to one exemplary embodiment described herein, wherein the host's memory includes two storage spaces, and as illustrated with different fill patterns in FIG. 2C, including non-reserved storage space A (filled diagonally), used by the kernel, and reserved storage space B (filled vertically and grayed out), used by the virtual machine. That is, non-reserved storage space A provides memory for the kernel depicted in the figure, applications running on the operating system (such as those exemplified in Applications 1-3 in FIG. 2C) can utilize the non-reserved storage space A. The reserved storage space B can be used by virtual machines (VM), as shown in the FIG, with VM1 to VMn being N virtual machines. The two storage spaces may have different management granularity, that is, the way of dividing memory can be different. For convenience of illustration in FIG. 2C, the two storage spaces are illustrated consecutively in the diagram. It should be understood that in actual applications, the two storage spaces do not necessarily need to be continuous.

The reserved storage space occupies a large part of the memory and is not available to the host kernel, so a module dedicated to managing the reserved storage space can be inserted in the operating system's kernel. In order to facilitate management of the series of memory while avoiding occupation of memory by excessive metadata, as well as considering that when allocating memory for virtual machines, they are often at least hundreds of MBs (megabytes), therefore, the reserved storage space is divided into larger granularity, such as the reserved storage space is divided into memory blocks (MS) with sizes like 2M for management; in some scenarios, large granularities are also commonly used, such as 1 GB (gigabytes), which are optional in the embodiment.

In some examples, the memory swapping method of the embodiment can be applied to all storage space in a memory; and in other cases, it may also apply to part of the storage space. For example, in reserved memory scenario as mentioned above, the storage space in the memory has been specifically reserved for use by virtual machines.

When applied to a reserved memory scenario, an operating system can manage the reserved storage space and non-reserved storage space separately by using different modules. The method of the embodiment may be used in an operating system for processing data swapping between reserved memory and target memory.

In some other examples, a computer device can be a device that includes multiple physical CPUs and adopts Non Uniform Memory Access (NUMA) architecture according to needs. The NUMA architecture includes at least two NUMA nodes, as shown in FIG. 2D. Taking two NUMA nodes as an example, a host computer can include NUMA node 1 and NUMA node 2. In the NUMA architecture, multiple physical CPUs and multiple memories of the host computer are subordinate to different NUMA nodes. Each NUMA node includes at least one physical CPU and at least one physical memory. For illustration purposes, FIG. 2D shows that each NUMA node has only one physical CPU and one physical memory. Within the NUMA node, communication between the physical CPU and the physical memory is performed via an Integrated Memory Controller Bus (IMC Bus), while communication between NUMA nodes is performed via Quick Path Interconnect (QPI). Since the delay of QPI is higher than that of IMC Bus, the access by physical CPUs in the host to memory has a distinction between remote and local memory access. Physical CPUs have faster access to physical memory on the node, while accessing physical memory on other NUMA nodes is slower.

In a NUMA architecture scenario, the memory of the embodiment can include any physical memory mentioned above. In one implementation mode, each physical memory in the NUMA architecture may also adopt a reserved memory architecture. Based on this, the storage space managed by the embodiment may also refer to the reserved storage space in any physical memory in the NUMA architecture.

It can be understood that, in actual application, computer device may also adopt other architectures according to practical needs. In the embodiment of the present disclosure, various implementations of memory are possible depending on specific application scenarios and will not be listed one by one hereinafter.

In practical application scenarios, there can be multiple target memories such as non-transitory memory (NVM), hard disk or optical disc. The embodiment does not limit this. In some examples, a computer device may have multiple memories, and the memory used to perform data swapping with main memory can be one or more. For example, it is also possible to select one of these memories as the target memory for data swapping according to needs, and selection rules flexibly configured based on requirements. The embodiment does not limit this.

As shown in FIG. 2B, the method of the embodiment may include a pending task is acquired 212, and a pending swapping task may include a swap out task or a swap in task. The pending swapping tasks can be acquired through various ways. As an example, a memory management module of the operating system may have a memory aging management function that manages cold-hot changes of each memory block in the memory and maintains metadata indicating the hot-cold state of the memory according to needs. The use situation of each memory block in the memory can be scanned to determine the hot-cold state of each memory block. For instance, a cold page set can record the memory blocks in a cold state, while a hot page set records the memory blocks in a hot state. As an example, memory blocks that need to be swapped out to secondary storage can be determined by using the cold page set.

Similarly, there are also multiple ways to obtain swap in tasks. For example, process that should be swapped in memory is determined based on hot-cold state data. All or part of the data from the process that was swapped out in secondary storage is selected for swap in the memory. Or, when an operating system detects a page fault anomaly, it determines the memory block in the memory for swap in the data needed to be swapped in target memory.

In some cases, there can be many ways to acquire a pending swapping task. For example, an the memory aging management function of the operating system may identify whether there are any blocks of memory that can be swapped out based on set cycles. In one identification cycle, it might recognize data in multiple continuous or non-continuous memory blocks requiring swap out, and based on which multiple pending swapping tasks are generated. Or, it could also recognize that the data accessed by the process is not stored in the memory but in a target memory and is required to be swapped from the target memory to the memory, based on which a pending swapping task is generated. It should be understood that in other scenarios, the generation methods for the pending swapping tasks can also vary in numerous ways, which will not be listed here individually.

In some examples, as shown in FIG. 2B, data for recording information of each pending task can be stored in memory. By accessing the storage location of the data in the memory, it is executed whether there are no pending tasks 222; if there are no pending tasks, then current flow will end; if there is a pending task, step 224 that taking out a pending swapping task will be performed.

In some examples, a pending swapping task may be a swapping task for one memory block, that is, only one memory block can be processed in each swap process. In other examples, it may also be a swapping task for multiple continuous memory blocks, that is, at least two consecutive memory blocks can be processed in each swap process. In other cases, it is optional to process non-consecutive multiple memory blocks, and the embodiment does not limit to such case.

In actual applications, the pending tasks may include one or more information such as a task type is configured to indicate that the task is a swap out task or a swap in task, size information of data needed to be swapped or address information of memory blocks needed to be swapped. It can be configured according to needs in practice and which is not limited in the embodiment.

In case that pending tasks are swap out tasks, there may not be enough storage space in the target memory to store data swapped from the memory. Based on this, it can first determine whether there is available swap out storage space in the target memory before sending a request for swapping with the memory block. For example, according to the memory block of the data to be swapped, the size of the required swap out storage space is determined, and an idle storage space is attempted to be allocated to the target memory. If allocation fails, then the current swap out task will fail; if allocation is successful, subsequent processes can continue.

In practical applications, a swapping request can be created for the target memory based on the operating system type actually applied and the target memory actually used. For example, if the operating system is Linux (a name of an operating system), and the target memory is a disk, then the swapping request could be a BIO (Block input output, block device input or output) request. In other examples, there is a driver provided by the target memory, the swapping request may also be implemented through calling the interface provided by the driver of the target memory. Depending on the type of the pending tasks, the swapping request may include both swap out requests and swap in requests.

In actual applications, swapping requests can be asynchronous or synchronous requests. For example, a swap out request may be an asynchronous request, a swap in request can be a synchronous request, and it is not limited in the embodiment. Then, step 226 may execute to initiate a swapping request towards the target memory. In some examples, if the swapping request is an asynchronous request, after sending the swapping request toward the target memory, it can return to process next pending task; if the swapping request is a synchronous request, it can wait synchronously for completion message for the target memory to commit after submitting the request.

The number of processes that need to run in an operating system is generally greater than the core of a CPU, and for one CPU core, under scenarios supporting multi-process operating system, the CPU will quickly switch between different processes, with each process running tens or hundreds of milliseconds at most. A single process can include multiple threads. In the implementation, after a swapping request is sent out, due to the time required by target memory to swap data, during the period from sending out the swapping request until completion of the swapping on the target memory, the CPU may switch to other processes, or it may switch to other threads within the same process in the implementation. When receiving the message indicating completion of the swapping returned by the target memory, since the target memory belongs to an external hardware equipment, it represents an interrupt request for the operating system, which interrupts the current executing task. Therefore, the response tasks of the interrupt request should be executed as soon as possible so as to reduce the impact on normal process scheduling. It can be understood that the interrupted current task by the operating system may be another process's task, or it may be a thread under the process where the memory swapping module is located.

Therefore, after the target memory completes sending a completion message of a swapping request 232, the embodiment can execute steps that page table is updated 234 and metadata update task is added 236. The embodiment designs that when an interruption occurs, operations performed are to update information in the page table of the memory block and add a metadata update task of the memory block to a preset task queue. Since during the process of updating metadata, other processes/threads such as metadata query, hot upgrade tasks or cold-hot page scans may take locks on metadata, there is also a possibility that the lock will be held by interrupted processes and cause long-term blocking. Based on this, at the time of interruption, the tasks executed by the embodiment do not include metadata update tasks, so no locking is required to be taken on metadata, thereby reducing the probability of blocking and improving the efficiency of task recovery.

In actual applications, the operating system allocates each process with an independent set of virtual addresses and uses page tables to map virtual addresses of different processes and physical addresses of different memories. Each process corresponds to a set of page table data. The page table information for the memory block in the embodiment is from the page table of the process that owns the memory block. In practical applications, to reduce the storage space occupied by page table data and quickly find the mapping relationship between virtual addresses and physical addresses, some operating systems also adopt multi-level page table solutions, i.e., the page table data of each process can include multiple directory items at levels. Taking common four-level page tables as an example, the page table data includes the following four pieces of data recorded with page table directory items:

Global page directory item, PGD (Page Global Directory);

Upper page directory item, PUD (page upper directory);

Middle page directory item, PMD (Page Middle Directory);

Page table entry, PTE.

The specific information recorded in the above four-level page table and the process of querying mapping relationship between virtual addresses and physical addresses through a page table can be referred to related art, which are not described here.

Therefore, updating the page table information of the memory block in the embodiment can be updating the information of the memory block in the page table data of the process where the memory swapping module is located, and the process is determined according to the physical address of the memory block that is required to swap data. For example, in a swap out task, the virtual address VA1 corresponds to the physical address PA1 of the memory block recorded in the page table; since the data of the memory block is swap out to the target memory at the address DA1, therefore, the record corresponding to VA1 and PA1 in the page table will be updated as VAI corresponding to DA1. The swap out task works similarly, updating the record corresponding to VA1 and DA1 in the page table to corresponding to VA1 and the physical address of the memory block.

As described above, some page table data in some examples include four-level data and need to be updated for all of them. In actual applications, they can be flexibly configured according to needs. The embodiment does not limit this aspect.

The metadata of the embodiment includes any metadata used by an operating system to maintain memory, and can include but is not limited to metadata indicating whether a memory block is allocated, total metadata for memory, cold-hot state metadata for memory blocks, memory allocation data MMAP of processes to associated with each memory block in memory. In practical applications, under different application scenarios, there may be various types and implementations of metadata, which are not restricted in the embodiment. Taking the virtual machine scenario as an example, some schemes have dedicated computer devices for virtual machines, and in the scheme of allocating memory for virtual machines, fixed virtual address spaces are configured for individual virtual machines. To facilitate querying the correspondence between virtual addresses and physical addresses, metadata MMAP representing the status of memory allocation was additionally created based on page table data, to record the correspondence between virtual addresses and physical addresses in memory, which can be used for enabling bidirectional queries between virtual addresses and physical addresses, and improving query efficiency. It should be understood that in certain scenarios where no memory allocation data MMAP for processes associated with each memory block in memory is required, the embodiment does not impose restrictions.

Since metadata of the memory block records status information about the allocation status or old hot state of the memory block, taking swap out tasks as an example, the data in the memory block has been successfully swapped to target memory. The delay update of metadata will cause a delay for re-allocation of the memory block, but it won't lead to errors in the data itself; similarly, when performing swap in tasks, the data in the memory block has been successfully swapped to the memory. Since the memory blocks that are being swapped have already been marked as allocated when the swap in tasks were generated, delaying allocation status updates would not result in any data errors or memory management errors.

The timing of processing the preset task queue can be flexibly configured according to needs, for example, in actual applications there may be multiple tasks waiting to be processed. Metadata update tasks in the task queue could be executed when idle time occurs, such as detecting that no pending swapping tasks exist. For example, the method in the implementation executes step 242 to determine whether the task queue is empty at an idle time and ends if the task queue is empty; otherwise, metadata is updated 246 after a metadata update task is retrieved from the task queue 224.

In some examples, after determining a memory block that is required to be swapped for data, the method may further include:

The metadata update task of the memory block is created and written to a first storage space;

The metadata update task of the memory block is added to a preset task queue includes:

The metadata update task of the memory block from the first storage space is queried, and an address of the metadata update task of the memory block is added to the preset task queue.

In the embodiment, a storage space in memory can be allocated to store the preset task queue. Thus, the preset task queue may be cached in memory. The queue is arranged for storing metadata update tasks, where the number of queues can at least one and can be flexibly configured according to needs. For example, it can be a single task queue, and metadata update tasks corresponding to both swap out tasks and swap in tasks are placed into the same queue. It can also be that there are two queues, and the swap out tasks are corresponded to one queue and the swap in tasks are corresponded to another queue. Multiple metadata update tasks can be stored in each queue. In an exemplary manner, in the reserved memory architecture, the first storage space can be located outside the non-reserved storage area or inside the reserved storage area.

The metadata update tasks can carry one or more pieces of information to describe the metadata update tasks. For example, it may include data representing a memory block corresponding to the task, such as physical addresses or virtual addresses of swapped memory blocks, and also includes a swapping task corresponding to the task, for example operation types (swap in or swap out), physical address of target memory when swapping, page table information, associated callback functions, etc., in actual applications it can be flexibly configured according to needs.

In the embodiment, since a metadata update task is created after determining which memory block is required to be swapped for data, when interrupted, it can query out the metadata update task of the memory block from the first storage space and directly add the address of the metadata update task to the preset task queue. Therefore, the enqueue operation can quickly complete, thereby improving the processing efficiency of an operating system in handling interruptions so that tasks being interrupted can recover rapidly.

In some examples, the preset task queue can be a lock-free queue. Adding metadata update tasks to the queue is an enqueue operation and removing metadata update tasks from the queue is a dequeue operation. Lock operations will reduce processing speed. The setting of a lock-free queue allows for dequeue and enqueue without holding locks on the queue, directly performing the required enqueue or dequeue operations on the queue, thereby improving processing efficiency and avoiding new lock competition when dequeuing and enqueuing metadata update tasks.

In some examples, the method further includes: after initiating a swapping request with target memory block to the target memory, in response to receiving a swapping cancellation message, the metadata update task of the target memory block is deleted from the first storage space. In the embodiment, the metadata update task is pre-created and stored in the first storage space. Since there may be errors during swapping or other operations performed on the swapped memory blocks that ultimately result in the cancelation of the swapping, if a swapping cancellation message is received, it indicates that the swapping has been canceled, so the metadata update task for the target memory block will be deleted from the first storage space, thereby reducing occupancy of the first storage space.

In some examples, the pending swapping task includes a pending swap out task. After determining target memory block that requires data swapping, the method further includes: write protection on page table information corresponding to the target memory block is applied; the page table information of the target memory block is updated includes: after removing the write protection on the page table information of the target memory block, the page table information of the target memory block is updated. In the embodiment, after determining the target memory block that requires data swapping, it is possible to timely perform write protection on the page table information corresponding to the target memory block. The write protection can set the page table as read-only status so that the content stored in the target memory block will not be changed during swap out process and avoid inconsistent problem caused by changing the content stored in said target memory block.

In some examples, the method further includes: after initiating a swapping request with respect to the target memory block, in response to receiving a swapping cancellation message, write protection on the page table information of the target memory block is removed. Since during the swapping process, there may be errors in swapping or other operations performed on the swapped memory blocks that ultimately lead to the swapping being cancelled, if a swapping cancellation message is received, then the swapping will be cancelled. Therefore, timely remove the write protection of the page table information of the target memory block so as to restore normal read/write status without affecting other tasks'normal reading/writing access to the page table information of the target memory block.

The following examples will be described in detail.

For example, taking a swap out task as an example, the processing can include:

Step 1, the memory block to be swapped out, MS (memory section), is obtained. For example, a memory block MS can be selected from the cold page set that is required to be swapped out; if there is no such memory block, it will fail, otherwise continue. For example, in batch processing scenarios, the starting physical address, PADDR (physical address), which can directly convert to the starting memory block MS, and the size, size (which can be converted to multiple MS sizes) of the memory block to be swapped out are obtained, to obtain multiple memory blocks MS to be processed in batches.

Step 2, the memory allocation data MMAP of the pending output memory block MS are queried, which is convenient for subsequent conversion from physical address PADDR to virtual address VADDR (virtual address), and then obtain page table entries PMD through VADDR. In some examples, MMAP of all processes are in a single piece of data, such as in a linked list, so a lock is required when querying MMAP by MS, that is, the linked list is temporarily locked to obtain the MMAP corresponding to the MS through traversal and query. In one implementation method, in the batch processing scenario as described above, it can also be optionally established for an entire copy of the MMAP data according to needs. For example, when querying the first memory block MS waiting to be replaced by batch processing, the entire MMAP is locked before establishing a copy, then releasing the lock after creating the copy. Other memory blocks waiting to be replaced by batch processing may utilize the copy to query the corresponding MMAP.

Step 3, according to MMAP, the virtual address VADDR corresponding to the memory block MS and a page table entry PMD (for example at a granularity of 2M) corresponding to the memory block MS are obtained.

Step 4, the target memory is selected. The computer device may include one or more secondary storage, and select one of them as a device for swapping purposes, which is commonly used in Linux systems such as BIO disk storage; and taking BIO as an example to illustrate.

Step 5, an idle storage space DS (device section) from disk attempts to be allocated, which is similar in size to MS.

Step 6, in memory, a cache pool for storing metadata update tasks is pre-allocated and maintained, one piece of data in the cache pool is allocated to record information about the metadata update tasks, which is called cache structure COPS (cache operation); if the allocation of the piece of data fails, it indicates that there is not enough space in the memory to create a metadata update task of the current swapping task, then exit; otherwise continue.

Step 7, the cache structure COPS is initialized, operation types TYPE, source memory address MS, corresponding virtual addresses VADDR, target address DS, memory page table item PMD, and associated callback functions OUT_CB are recorded, at the time a metadata update task for the swap out task is created. For example, the callback function OUT_CB can be associated with the callback function BIO_CB associated with the BIO request, wherein the input parameter of the function BIO_CB is the cache COPS, used to add COPS to the task queue.

Step 8, a BIO request is created, including the type of BIO request, the physical address PADDR corresponding to the memory MS that is about to be swapped in the BIO request, and the corresponding disk SECTOR of target memory DS, and the number of pages requested by BIO (converted to a granularity of 4K); since BIO is an asynchronous operation, it also is required to be associated with the callback function of BIO. Among them, the callback function refers to the function that sends out the request after sending out the request for the target memory, which will handle successful messages returned from successfully swap out; the operating system executes the function BIO_CB according to the association here when receiving the message indicating success in handling. Since the function BIO_CB adds cache COPS to the task queue, and the cache COPS are associated with the function OUT_CB, therefore, once the cache COPS exits the queue, call the function OUT_CB inside the cache cop, wherein the function OUT_CB handles the cache COPS as described in step 7. The cache COPS records information such as operation type, source memory address, etc., so the function OUT_CB can use these information to complete the metadata update task of the cache COPS.

Step 9, the page table corresponding to virtual address VADDR is changed to read-only, so that the content of memory will not be changed during swapping and data inconsistency can be avoided.

Step 10, a swap out request is initiated to the disk. For example, it can call the BIO interface and submit created BIO requests; so that the disk will according to submitted BIO requests, write the content in virtual address VADDR to the position of DS applied for in step 5.

Step 11, wait for completion; in case of the BIO requests are asynchronous requests, it can return to process the next swapping task and continue when the callback function is awakened by the write request from BIO.

Step 12, if there is a write error or the writing process is cancelled, for example during the writing to target memory, if other threads/processes perform read/write operations on block MS, the swapping can be cancelled according to need. For example, the cancellation mark CANCEL is set in COPS; if there is a mark CANCEL, execute step 13; otherwise, execute step 14.

Step 13, if there is a write error or the writing process is cancelled, the read-only status of the page table corresponding to the virtual address VADDR needs to be changed back to a readable and writable state, then return.

Step 14, after successful write to the target memory, a success message is returned. That is, the callback for the BIO write request wakes up and indicates that the swap out was successful, and it is required to update the page table corresponding to virtual address VADDR by recording its position DS in the target memory within the page table entry. At the same time, the flag PRESENT of the page table is set. The flag indicates whether there is an associated memory block with the virtual address VADDR so as to facilitate subsequent process access recovery. For example, when the flag is cleared, it means that the virtual address VADDR does not correspond to any memory blocks but rather corresponds to the target memory. In such cases, the aforementioned page fault exception will be triggered, the operating system is required to perform the swap in task to swap data from the target memory back in the memory.

Step 15, since the asynchronous return call of bio is a single interruption, the operating system is required to interrupt context and avoid situations where it is blocked for a long time due to waiting on spin locks; update metadata in step 17 requires taking a lock, which has a probability of not being able to take the lock and waiting for a long time. Based on this, the embodiment adds the metadata update task to a lock-free queue.

Step 16, a cached metadata update task is dequeued from a lock-free queue when there is idle time. The lock-free queue can include multiple metadata update tasks.

Step 17, for each metadata update task, a lock on the metadata is obtained and the corresponding metadata is updated; for example, the metadata includes allocation status data of memory blocks, cold-hot state data, memory allocation data using MMAP, etc.

Step 18, whether the lockless queue is empty is determined; if the lockless queue is not empty, return to step 16; otherwise complete.

For example, taking a swap in task as an example, the processing can include:

Step 1, process a to be swapped in memory is determined based on cold and hot state data, and its memory allocation data MMAP is found, so that it can be arranged for subsequent queries and updates.

Step 2, a secondary storage is selected as a swapping source device.

Step 3, one virtual memory VADDR that has been swapped out is selected from the memory allocation data MMAP of the process, and whose content is located at storage block DS in secondary storage. In other examples, it has other ways to determine which memory blocks need to be swapped in, such as when an operating system discovers page fault anomalies, it determines the needed swap in memory blocks based on the target memory for the data needing to be swapped.

Step 4, one or more memory blocks MS in memory for swapping data are allocated, and exit if it fails; otherwise continue.

Step 5, a cache structure COPS in the cache pool arranged for storing metadata update tasks is allocated; if it fails, it indicates that there is not enough memory space to create an updated metadata update task of the current swapping task and exit; otherwise continue.

Step 6, the operation cache structure COPS is initialized, and the operation type TYPE, source memory address MS, corresponding virtual address VADDR, target address DS, memory page table item PMD, and associated callback function IN_CB are recorded.

Step 7, a BIO request is created, which includes the type of the BIO request, the physical address PFN corresponding to the memory MS that is required to be swapped, the disk sector SECTOR corresponding to the target memory DS, and the number of pages (converted to granularity of 4K) of the BIO request. Since BIO is an asynchronous operation, it also associates with the callback function BIO_CB of BIO.

Step 8, a start swap in flag FLAG is set, which will wait for the flag to be cleared later. For example, the swap in flag can be set by using a global variable or a field variable in COPS; The swap in flag FLAG indicates that the swap in task is required to synchronously wait for the clearing of the swap in flag FLAG before returning from the swap in task, i.e., after the swap in flag FLAG is cleared, the swap in task can return and complete the swap in task.

Step 9, a swap in request is initiated to the disk. Specifically, it can call the BIO interface, submit created BIO requests, call the read function of the disk, and write data stored in the DS position on the disk into the memory block corresponding to the virtual address VADDR. In the embodiment, the swap in request may be a synchronous request that requires synchronization waiting for completion of reading from memory before returning.

Step 10, the callback function for waiting for a BIO read request is awakened.

Step 11, the read request callback of BIO is awakened, and the swap in succeeds. It is required to update the page table corresponding to virtual address VADDR, update the corresponding physical address PFN information to the page table. Then it can be directly read or written later.

Step 12, similarly, due to the asynchronous return call of BIO in interrupt context, it is necessary to avoid similar situations where long-term blocking occurs by waiting for spin locks. The update metadata step 14 will need a lock and there is a probability that the lock cannot be obtained. Based on this, the embodiment adds the metadata update task to a lock-free queue.

Step 13, the swap in flag is cleared, and the main process ends waiting for swap in.

Step 14, a cached metadata update task is dequeued from the lock-free queue when there is idle time. The lock-free queue can include multiple metadata update tasks.

Step 15, for each metadata update task, a lock on the metadata is obtained and the corresponding metadata is updated; for example, the metadata includes allocation status data of memory blocks, cold-hot state data, memory allocation data MMAP, etc.

Step 16, whether the lockless queue is empty is determined; if the lockless queue is not empty, return to step 14; otherwise, complete the replacement process.

Corresponding to the embodiments of the memory swapping method described above, the present disclosure also provides an embodiment of a memory swapping device and its application computer device.

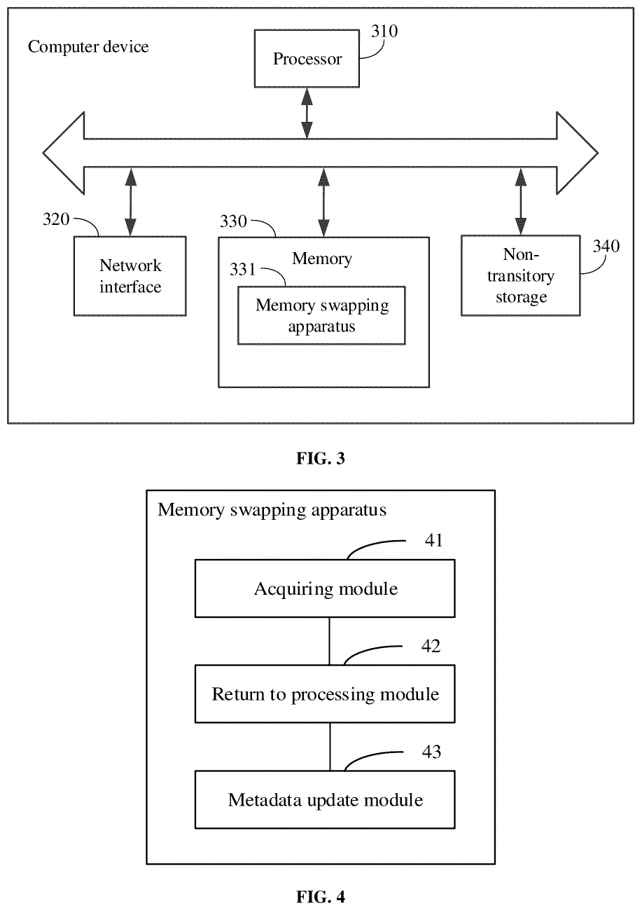

The embodiments of the memory swapping device described in the present disclosure can be applied to computer devices, such as servers or terminal devices. The implementation examples of the device can be realized through software, hardware, or a combination of both. Taking software realization as an example, from a logical perspective, it is formed by reading corresponding computer program instructions stored in non-transitory storage into memory and running them on the processor. From a hardware level, as shown in FIG. 3, it is a schematic diagram of the hardware structure of the computer device where the memory swapping apparatus according to the present disclosure is located. In addition to the components shown in FIG. 3, namely processor 310, memory 330, network interface 320, and non-transitory storage 340, other hardware may also be included in the computer device where a memory swapping apparatus 331 in the embodiment is located based on its actual functions, which will not be elaborated upon here.

As shown in FIG. 4, FIG. 4 is a block diagram of a memory swapping apparatus according to some embodiments of the present disclosure, which includes:

an acquiring module 41, is configured to acquire a pending swapping task, determine a memory block that requires data swapping according to the pending swapping task, and send a swapping request corresponding to the memory block to a target memory;

a return processing module 42, is configured to in response to receiving a swapping completion message returned by the target memory, interrupt a first task currently being executed, and perform an operation for updating page table information of the memory block and add a metadata update task of the memory block to a preset task queue, and resume the first task after the operation is completed.

A metadata update module 43, is configured to if it detects that a preset condition has been met, process the metadata update task in the preset task queue.

In some examples, the acquiring module 41 is also configured to create the metadata update task for the memory block after determining a memory block that requires data swapping according to the pending swapping task, and write it into first storage space of the memory.

The metadata update module 43 is configured to query the metadata update task of the memory block from the first storage space, and add an address of the metadata update task of the memory block to the preset task queue.

In some examples, the preset task queue includes a lock-free queue.

In some examples, detecting that the set condition is met including detecting that there are no pending swapping tasks at the moment.

In some examples, the device further includes a deletion module, which is configured to after initiating a swapping request with the target memory block, in response to receiving a swapping cancellation message, delete the metadata update task of the memory block from the first storage space.

In some examples, s the pending swapping task includes a pending swap out task. The acquiring module 41 is further configured to after determining target memory blocks that requires data swapping, apply write protection on page table information corresponding to the target memory block.

The updating the page table information of the target memory block includes: after removing the write protection on the page table information of the target memory block, updating the page table information of the target memory block.

In some examples, the device further comprises a release module, which is configured to after initiating a swapping request with target memory block to the target memory, in response to receiving a swapping cancellation message, removing the write protection on the page table information of the target memory block.

The technical solutions provided by embodiments of the present disclosure can include the following beneficial effects:

In the embodiments of the present disclosure, in response to receiving a swapping completion message returned by the target memory, after an operating system interrupts a first task currently being executed, operations performed are updating page table information and adding a metadata update task of the memory block to a task queue. Compared with traditional techniques, the number of execution of the tasks for updating metadata is reduced, there is no need to hold locks on metadata, the probability of getting stuck in long-term blocking during interruptions is reduced, and recovery speed upon interruption is improved.

The specific implementation process of functions of each module in the above memory swapping apparatus is detailed in the corresponding steps of the memory swapping method, which will not be repeated here.

Accordingly, some embodiments of the present disclosure also provides a computer program product, including a computer program that is executed by the processor to implement steps of the memory swapping method embodiments described above.

Accordingly, some embodiments of the present disclosure also provides a computer device including a memory, a processor and a computer program stored in the memory, and the computer program is executed by the processor, wherein the processor executes the computer program to implement the steps of embodiments of the method for implementing memory swapping.

Accordingly, some embodiments of the present disclosure also provides a computer-readable storage medium, storing a computer program, the computer program being executed by a processor to implement the steps of embodiments of the memory swapping method.

For device embodiments, since they are basically corresponding to method embodiments, relevant information can be found in part of the description for method embodiments. The above-described device embodiments are merely illustrative examples. Modules described as separate components may or may not physically separated, and parts shown as modules may or may not be physical modules, i.e., located at one place or distributed over multiple network modules. Part or all of these modules can be selected according to actual needs to achieve the purpose of the present disclosure. A person skilled in the art without creative labor can understand and implement it.

The above embodiments can be applied to one or more computer devices, wherein the computer device is a device that automatically performs numerical calculation and/or information processing according to instructions preset or stored in advance. The hardware of the computer device includes but not limited to microprocessors, application specific integrated circuits (ASIC), programmable gate arrays (FPGA), digital signal processors (DSP), embedded devices etc.

The computer device mentioned herein can be any type of equipment, such as servers; it may also include electronic products that are capable of interacting with users in a human-machine manner, such as personal computers, tablet PCs, smartphones, Personal Digital Assistants (PDAs), game consoles, interactive internet protocol televisions (IPTVs), smart wearable devices and so on.

The computer device described above may also include network devices and/or user equipment. Among them, the network device includes but is not limited to a single network server, multiple servers in a group of servers, or a cloud based on cloud computing, which consists of many hosts or network servers.

The computer device is located in a network that includes, but not limited to Internet, wide area networks (WAN), metropolitan area networks (MAN), local area networks (LAN), virtual private networks (VPN).

The above description refers to specific embodiments of the present disclosure. Other embodiments are within the scope of appended claims. In some cases, actions or steps recorded in the claims can be performed in a different order than that described in the embodiment and still achieve expected results. Additionally, the process depicted in the drawings does not necessarily require the particular sequence or continuous sequence shown for achieving an expected result. In certain implementations, multitasking and parallel processing may also be possible or advantageous.

The steps of various methods described above are only for description, and can be merged into one step or divided into multiple steps when implemented. As long as they include the same logical relationship, they fall within the protection scope of the present disclosure. Adding irrelevant modifications to algorithms or processes, or introducing irrelevant designs but not changing their core design falls within the protection scope of the present disclosure.

Among them, descriptions such as “specific examples” or “some examples” refer to that specific features, structures, materials or characteristics described in combination with the embodiments or examples are included at least one embodiment or example of the present disclosure. In the present disclosure, the illustrative expressions for these terms do not necessarily mean the same embodiment or example. Moreover, the specific features, structures, materials or characteristics can be appropriately combined in any one or more embodiments or examples.

After considering the application and the invention described in the specification, those skilled in the art will easily think of other implementations of the present disclosure. The present disclosure is intended to cover any variations, uses or adaptability changes of the present disclosure that follow the general principles of the present disclosure and include common knowledge or conventional technical means within the scope of the present technology field but not claimed by the present disclosure. The specification and examples are only considered as exemplary, and the true range and spirit of the present disclosure are indicated below in the claims.

It should be understood that the present disclosure is not limited to the precise structure described above and shown in the drawings, but various modifications and changes can be made within its scope. The scope of the present disclosure is only restricted by the appended claims.

The above description is only a preferred embodiment of the present disclosure, and it should not be used to limit the present disclosure. Any modification, equivalent replacement or improvement within the spirit and principle of the present disclosure shall fall within the protection scope of the present disclosure.

1. A memory swapping method, comprising:
acquiring a pending swapping task, determining a memory block that requires data swapping according to the pending swapping task, and sending a swapping request corresponding to the memory block to a target memory;
in response to receiving a swapping completion message returned by the target memory, interrupting a first task currently being executed, and performing an operation for updating page table information of the memory block and adding a metadata update task of the memory block to a preset task queue, and resuming the first task after the operation is completed; and
in response to detecting that a set condition is met, processing the metadata update task in the preset task queue.

2. The method as claimed in claim 1, after determining the memory block that requires data swapping according to the pending swapping task, further comprising:
creating the metadata update task of the memory block and writing the metadata update task to a first storage space; and
adding the metadata update task of the memory block to the preset task queue comprising:
querying the metadata update task of the memory block from the first storage space, and adding an address of the metadata update task of the memory block to the preset task queue.

3. The method as claimed in claim 2, the preset task queue comprising a lock-free queue.

4. The method as claimed in claim 1, detecting that the set condition is met comprising:
detecting that there are no pending swapping tasks at the moment.

5. The method as claimed in claim 2, further comprising:
after initiating a swapping request with target memory block to the target memory, in response to receiving a swapping cancellation message, deleting the metadata update task of the memory block from the first storage space.

6. The method as claimed in claim 1, the pending swapping task comprising a pending swap out task, and after determining target memory block that requires data swapping, further comprising:
applying write protection on the page table information corresponding to the target memory block; and
updating the page table information of the target memory block comprising: after removing the write protection on the page table information of the target memory block, updating the page table information of the target memory block.

7. The method as claimed in claim 6, further comprising:
after initiating a swapping request with target memory block to the target memory, in response to receiving a swapping cancellation message, removing the write protection on the page table information of the target memory block.

8. (canceled)

9. A computer device, comprising a memory, a processor, and a computer program stored in the memory and the computer program is executed by the processor, wherein the processor executes the computer program to implement following steps:
acquiring a pending swapping task, determining a memory block that requires data swapping according to the pending swapping task, and sending a swapping request corresponding to the memory block to a target memory;
in response to receiving a swapping completion message returned by the target memory, interrupting a first task currently being executed, and performing an operation for updating page table information of the memory block and adding a metadata update task of the memory block to a preset task queue, and resuming the first task after the operation is completed; and
in response to detecting that a set condition is met, processing the metadata update task in the preset task queue.

10. A computer-readable storage medium, storing a computer program, the computer program being executed by a processor to implement following steps:
acquiring a pending swapping task, determining a memory block that requires data swapping according to the pending swapping task, and sending a swapping request corresponding to the memory block to a target memory;
in response to receiving a swapping completion message returned by the target memory, interrupting a first task currently being executed, and performing an operation for updating page table information of the memory block and adding a metadata update task of the memory block to a preset task queue, and resuming the first task after the operation is completed; and
in response to detecting that a set condition is met, processing the metadata update task in the preset task queue.

11. The method as claimed in claim 1, the pending swapping task comprises at least one of following: a task type indicating that the task is a swap out task or a swap in task, size information of data needed to be swapped or address information of the memory block.

12. The method as claimed in claim 1, further comprising:
selecting one of multiple memories for data swapping as the target memory according to selection rules.

13. The method as claimed in claim 1, the pending swapping task comprising a pending swap out task, and determining a memory block that requires data swapping according to the pending swapping task comprising:
determining the memory block by using a cold page set, wherein the cold page set records the memory blocks in a cold state.

14. The method as claimed in claim 4, detecting that there are no pending swapping tasks at the moment comprising:
detecting that there are no pending swapping tasks by accessing the storage location of data for recording information of each pending task in memory.

15. The method as claimed in claim 1, the pending swapping task is a swapping task for one memory block, or a swapping task for multiple continuous memory blocks, or a swapping task for non-consecutive multiple memory blocks.

16. The method as claimed in claim 1, before sending a swapping request corresponding to the memory block to a target memory, further comprising:
determining whether there is available swap out storage space in the target memory.

17. The method as claimed in claim 16, determining whether there is available swap out storage space in the target memory comprising:
determining the size of required swap out storage space according to the memory block;
attempting to allocate an idle storage space to the target memory;
in response to a successful allocation, determining there is available swap out storage space in the target memory;
in response to an unsuccessful allocation, determining there is no available swap out storage space in the target memory.

18. The method as claimed in claim 1, further comprising:
Creating the swapping request based on the operating system type and the target memory.

19. The method as claimed in claim 1, performing an operation for updating page table information of the memory block comprising:
determining the process where the memory swapping module is located according to the physical address of the memory block that is required to swap data; and
updating the information of the memory block in the page table data of the process.

20. The method as claimed in claim 1, processing the metadata update task in the preset task queue comprising:
retrieving the metadata update task from the task queue;
updating metadata.

21. The method as claimed in claim 1, the metadata update task comprises at least one of the following: data representing a memory block corresponding to the task, and a swapping task corresponding to the task.
